(19) United States
(12) Patent Application Publication
(10) Pub. No.: US 2025/0014214 A1
(43) Pub. Date: Jan. 9, 2025

(54) METHOD FOR DETERMINING THE POSITION OF FURNISHING ELEMENTS, IN PARTICULAR ELECTRONIC LABELS

(71) Applicant: CAPTANA GMBH, Ettenheim (DE)

(72) Inventors: Thomas SCHWARZ, Hohberg (DE); Andreas RÖSSL, Fernitz-Melach (AT); Francois ROBIN, Nanterre (FR)

(73) Assignee: CAPTANA GMBH, Ettenheim (DE)

(21) Appl. No.: 18/710,123

(22) PCT Filed: Dec. 16, 2021
(86) PCT No.: PCT/EP2021/086142

§ 371 Date: May 14, 2024

(51) Int. Cl. G06T 7/73; G01S 13/74; G06T 7/60

(52) U.S. Cl. CPC G06T 7/73; G01S 13/74; G06T 7/60; G06T 2207/30242

(57) ABSTRACT

A method for determining the position of furnishing elements, wherein a digital scene image consisting of pixels, in particular with a known pixel spacing or a known pixel dimension, and containing a digital representation of a first furnishing element, is generated using a camera from a scene captured by it, in which at least one first furnishing element is present and wherein the at least one first furnishing element image is automatically recognized in the scene image and a scale for the scene image is determined by determining the image points associated with the first furnishing element image in the scene image and knowing the actual dimensions of the first furnishing element.

### TECHNICAL FIELD

The invention relates to a method for determining the position of furnishing elements, in particular electronic labels, in retail premises, in particular on a shelf of the retail premises.

### BACKGROUND

In modern, digitized sales or retail premises, there has long been a need among retailers to enable precise digital mapping of furnishing elements, in particular of the electronic labels used there.

The invention is therefore based on the object of providing a method for determining the position of furnishing elements, in particular of electronic labels, that meets this long-standing need.

### SUMMARY OF THE INVENTION

This object is achieved by a method according to claim 1. The subject matter of the invention is therefore a method for determining the position of furnishing elements, wherein a digital scene image consisting of pixels, in particular with a known pixel spacing or a known pixel dimension, and containing a digital representation of a first furnishing element, is generated using a camera from a scene captured by it, in which at least one first furnishing element is present, and wherein the at least one first furnishing element image is automatically recognized in the scene image and a scale for the scene image is determined by determining the image points associated with the first furnishing element image in the scene image and knowing the actual dimensions of the first furnishing element.

The advantage of the measures according to the invention is that a fully automatic definition of the scale, which provides the basis for mapping, is generated for the scene image. On the one hand, this allows for precise mapping of the at least one first furnishing element in the scene, in other words, the provision of information about its position. On the other hand, it also allows for the measurement of further, namely second, furnishing elements which for their part are contained as second furnishing element images in the scene image and differ from the at least one first furnishing element, or for the provision of information on their position in the scene. With the help of the scale, actual dimensions can be directly “measured” from the digital scene image, i.e. converted from the scene image into the real scene.

Further, particularly advantageous embodiments and developments of the invention emerge from the dependent claims and also the following description.

The scene image is a two-dimensional data structure constructed by a matrix of pixels. This pixel matrix is formed by the camera, which has an optical imaging system (lens optics, also referred to as a lens) with which a real scene is captured and imaged analogously onto an electronic image sensor, which then performs the pixel-based digitization. Depending on the design of the electronic sensor, as well as the post-processing further camera electronics, a digital still image forming the digital scene image or also a digital video of the scene is generated. The resolution of the electronic image sensor and/or the digital post-processing defines the pixel resolution of the digital scene image, which is referred to in the technical jargon as pixel resolution. The scene image thereby generated by the camera for further processing is formed by a matrix of pixels, so for example 1500 pixels in the x-direction and 1000 pixels at right angles thereto in the y-direction. Each of these pixels has a defined (in other words, known) pixel dimension (or, in other words, the centre of adjacent pixels has a defined (in other words, known) pixel spacing).

The furnishing elements in the scene are therefore embedded as furnishing element images in the scene image with the help of the optical imaging system and the electronic image sensor, possibly also by means of post-processing of raw data provided by the electronic image sensor, and occupy or fill in pixels there. By knowing the occupied or filled pixels, it is now easy to convert to a dimension or measurement in reality, in other words in the scene, using the scale.

Furthermore, it should simply be mentioned that a modern digital camera naturally has an autofocus system and other functions that contribute to image capture and also image enhancement.

The further processing of the digital scene image to obtain the scale is carried out using a computer running software for image and/or pattern recognition. This software can also use artificial intelligence or be based on it entirely.

With the help of this software, the first furnishing element, or more precisely, the image of the first furnishing element (i.e. the furnishing element image), is searched for and identified. In this case, its contour in the scene image can be recognized, for example, by the software with knowledge of the contour of the furnishing element being searched for or of the appearance, or also of a specific characteristic manifestation of the first furnishing element. For this purpose, the software may have access to a description dataset describing the first furnishing element being searched for, which contains the digital parameterization of the first furnishing element relevant to the search, or also during the execution of the software, an optimized artificial neural network trained to recognize the first furnishing element may be applied.

Furthermore, the software also has knowledge of the actual dimensions of the first furnishing element for which dimension data accessible to the software is used, representing the actual dimension in the real scene.

Once the software has recognized the first furnishing element in the digital scene image, i.e. has found its structure in the pixel matrix of the digital scene image, thereby immediately identifying those pixels in the digital scene image that are associated with the first furnishing element, the scale is determined. The way in which the pixels associated with the first furnishing element are used for this purpose will be discussed in detail below.

The computer on which the software is run may be a server to which the scene image is transmitted from the camera, and on which the aforementioned dimensional data, as well as the description dataset or the artificial neural network required for recognition are implemented.

Of course, a single-chip design may also be present, which stands out due to its compactness and allows the measures to be integrated directly into the camera, which has proved to be a particularly preferred measure because all the measures necessary for the complete evaluation of the scene image are thereby implemented directly there and are locally applied where the digital scene image is generated. In other words, in an implementation with many different cameras, each generating its own scene image, a scale valid for the respective camera can be used locally. Furthermore, the computing power needed in order to evaluate the scene images is distributed as effectively as possible in this case among the plurality of cameras, and the computing power that is in any event available there is optimally used. In a particularly preferred embodiment, the computer already provided in the camera (e.g. as a microcontroller, ASIC or microprocessor, etc.) is also used for the purpose of this method according to the invention.

According to another aspect of the invention, it may be advantageous for multiple first furnishing element images, preferably identically configured first furnishing elements, to be identified in the scene image, where the actual dimensions of the underlying multiple first furnishing elements are known, and the scale for the scene image is determined with knowledge of the actual dimensions.

This measure can contribute to improving the accuracy of the scale.

However, this measure can also help scale the scale along the scene image, i.e. a scale is defined that depends on the location in the scene image. This location-dependent scale may be necessary, for example, if the scene image distorts the proportions of the first furnishing elements depicted therein. This kind of situation can occur, for example, when a scene extending far to the left or right side of the camera is captured with the help of the camera, as is the case in aisles in retail premises, for example. The first furnishing elements that are close to the camera will then be depicted larger than first furnishing elements positioned further away from the camera.

In connection with perspective images of this kind, it would also be possible to derive the course of the scale along the scene image from the distortion of a single furnishing element. However, if the length of this first furnishing element along the perspective to be evaluated is relatively short and, unfortunately, only a few pixels associated with the first furnishing element are available, this can lead to a very inaccurate result.

Therefore, multiple first furnishing elements of this kind are preferably used, which ideally occur somewhat evenly distributed along the perspective image, so that the function describing the location-dependent scale can be defined as accurately as possible. A scale of this kind is also referred to as a metric.

As already suggested, the invention forming the subject matter has its preferred application in the retail trade. The first furnishing element in this case, the actual dimensions of which are known (digitally in the form of dimensional data in units, e.g. millimetres), serves as a reference element for defining the scale. A reference element of this kind may have various embodiments. For example, it may be an entire shelf, the length of which is precisely known, for example. The use of the shelf may therefore be advantageous because it often plays a dominant part in a scene image. However, smaller objects, such as a shelf edge forming a front end of a shelf, for example, can also be used as a reference element. Shopping baskets set up to display goods in the retail premises are also suitable for this purpose, provided they are positioned within the capture range of the respective camera.

However, in the retail trade, shelves or shelf edges, as well as shopping baskets, are often supplied by a wide variety of manufacturers with very different dimensions for the respective retail premises of a wide variety of retailers, also often under specific structural specifications laid down by the retailers. Therefore, they are only suitable as first furnishing elements in a very narrow range of applications.

Against this background, it has proved particularly advantageous for the first furnishing element, the actual dimensions of which are known, to be formed by an electronic shelf label. The use of an electronic shelf label as the reference element is so advantageous because electronic shelf labels have substantially uniform dimensions. Of course, electronic shelf labels exist in a wide variety of sizes, with significantly varying dimensions. However, it has emerged in practice that the dimensions used hardly vary or only vary within a predefined range between different retail premises or even different retailers. This is particularly true for the plurality of electronic shelf labels installed on a shelf rail or the shelf rails of this shelf in a retail premises. Electronic shelf labels of this kind usually come in only one or two different dimensions per shelf. Since each of these electronic shelf labels must fit into the same shelf rail, they often differ in terms of their dimensions only in width, while the height is often identical for two different types of electronic shelf labels, for example. Their actual dimensions should therefore be classified as substantially homogeneous across different types of shelf labels, as well as across the installation locations.

As shelves with their shelf boards and the electronic shelf labels fastened to the shelf edges in each case are mainly found next to a plurality of different products which are identified by the electronic shelf labels in a scene image in a retail premises, the choice of electronic shelf labels as the reference element has proved particularly advantageous for another reason. Unlike in the case of the shelves themselves, or also the shelf edges etc., shelf labels are always attached to the foremost front of a shelf and can therefore be easily and unambiguously identified by means of digital image processing in the scene image captured using the camera.

In concrete terms, the determination of the pixels associated with the first furnishing element image in the scene image can be carried out using at least one of the measures listed below, specifically:
determination of the number of pixels occupied in a surface-like manner by the first furnishing element image. This allows the area occupied by the first furnishing element image in the scene image to be determined by counting the pixels (surface content expressed either as the sum of the counted pixels or surface content expressed as the total pixel area of the counted pixels) and with knowledge of the actual surface content of the first furnishing element (e.g. the surface content of the front surface of the first furnishing element expressed in square millimetres), the scale can be calculated;
determination of the number of pixels occupied by the first furnishing element image around its circumference or the number of pixels surrounding the first furnishing element image around its circumference. The circumference of the first furnishing element image in the scene image is determined by counting the pixels based either on the pixels just occupied by the first furnishing element image along its edges or based on the pixels immediately adjacent to the first furnishing element image. With knowledge of the actual circumference of the first furnishing element (e.g. the circumference of the front side of the first furnishing element), the scale can be calculated;
determination of the number of pixels occupied by the first furnishing element image along one of its boundary lines or the number of pixels surrounding the first furnishing element image adjacent to one of its boundary lines. The length of a boundary line is therefore used as a basis for determining the scale. This may, in particular, be a straight boundary line, such as one side of a rectangular or square structure of the first furnishing element, which may be given by housing edges, for example. Therefore, counting takes place either of pixels occupied along a boundary line of this kind or of pixels surrounding the first furnishing element image adjacent to one of its boundary lines. With knowledge of the actual length of the boundary line of the first furnishing element, the scale can be calculated.

In summary, it can be stated that the scale indicates a unit of area or length in the scene per pixel for the scene image.

According to another aspect of the method, at least one second furnishing element image is recognized in the scene image and using the scale for the scene image, at least one actual measurement for the second furnishing element underlying the second furnishing element image is determined. Based on the scale, real distance measurements in addition to other object images identifiable in the two-dimensional digital scene image (the second furnishing element images), as well as the actual (real) dimensions thereof, can be determined. Hence, in retail premises of a retailer, the additional objects can be electronic shelf labels other than those initially used, for example, or they can be products displayed on a shelf. However, the additional objects could also be entire shelves or also other items used for product presentation.

In this context, it should be noted that the actual measurement comprises at least one of those listed below, specifically:
an actual size measurement of the second furnishing element,
an actual distance measurement of the second furnishing element from another furnishing element also recognized in the scene image,
an actual position measurement of the second furnishing element within the scene captured by the camera. This allows for various statements to be made regarding the positioning, and also the orientation, of the other second furnishing elements.

In particular, based on the totality of the first and/or second furnishing element images recognized in the scene image and using the scale for the scene image, a first data structure is generated that represents a two-dimensional digital map of the furnishing elements in the scene, specifying the actual measurement(s) needed for two-dimensional cartography. The required measurements are determined by the requirements of the two-dimensional digital map. Hence, for example, only linked measurements (in other words, relative measurements indicating the distances of the furnishing elements from one another) may be required, in order to determine the positions of the furnishing elements. Absolute measurements from a point of origin or reference point may also be desirable.

This two-dimensional digital map of the scene image, which represents a projection of the scene onto the image sensor of the camera through the optical imaging device, is subsequently used to embed it into a three-dimensional context. According to this aspect of the method, the first data structure is converted into a second data structure by additional data, representing a three-dimensional digital map of the furnishing elements in a spatial region relevant to their positioning, wherein the additional data includes at least one of the following data elements, specifically:
distance data indicating the distance of the camera, in particular a mean or representative distance, from the scene captured by it, in particular the first furnishing element contained in the scene;
orientation data indicating the orientation of the camera in the spatial region;
tilt data indicating a tilt of the camera in relation to a reference, particularly the direction of gravity;
position data indicating a position of the camera within the spatial region.

In this case, the distance represented by the distance data can be determined in at least one of the following ways, specifically:
by pre-programming, which must be done once during the initial installation of the camera or its realignment, for example, and can possibly be initiated by preceding manual measurements;
by automatic calculation with knowledge of the parameters of the optical imaging system, which can be done fully automatically by the camera's computer, for example, because it can retrieve the parameters of the optical imaging system from one of its memories where they have been programmed in advance (e.g. during the manufacture of the camera), and because the computer knows the actual dimensions of the first furnishing element. Hence, for example, using the well-known lens equation, the distance to the real object can be calculated, wherein in this case the mapping function corresponding to the actual lens of the camera can of course be used;
by automatic determination by means of a distance sensor, wherein a LIDAR sensor or similar can be used for this purpose, enabling there to be a precise direct distance measurement, wherein the camera's computer further processes the data transmitted by the LIDAR sensor.

The pre-programmed distance data or the calculated distance data are stored in the server because they were calculated there. However, if the distance data is calculated in the camera or generated by automatic determination in the camera, then it is transmitted to the server, where it is used to create the three-dimensional map.

Furthermore, the orientation represented by the orientation data can be determined in at least one of the following ways, specifically:
by pre-programming, which, in this case too, must be done once during the initial installation of the camera or its realignment, for example, and can possibly be initiated by preceding manual measurements;
by automatic determination by means of an orientation sensor, wherein an electronic compass can be used for this purpose, for example, and the camera's computer further processes the data transmitted by the electronic compass.

The pre-programmed orientation data is stored in the server or the orientation data obtained by automatic determination is transmitted to the server, where it is used to create the three-dimensional map.

Furthermore, the tilt represented by the tilt data can be determined in at least one of the following ways, specifically:
by pre-programming, which, in this case too, must be done once during the initial installation of the camera or its realignment, for example, and can possibly be initiated by preceding manual measurements;
by automatic determination by means of a tilt sensor, wherein an electronic gyroscope can be used for this purpose, for example, and the camera's computer further processes the data transmitted by the electronic gyroscope.

The pre-programmed tilt data is stored in the server or the tilt data obtained by automatic determination is transmitted to the server, where it is used to create the three-dimensional map.

Furthermore, the position represented by the position data can be determined in at least one of the following ways, specifically:
by pre-programming, which, in this case too, must be done once during the initial installation of the camera or its realignment, for example, and can possibly be initiated by preceding manual measurements;
by automatic radio-based position determination, in particular with the help of “Ultra-Wideband (UWB) radio technology”, wherein preferably fixed UWB transmitters installed at various points in the relevant area are used for this purpose, and the camera has a UWB radio module with the help of which the position of the camera in relation to the UWB transmitter with which the camera is in UWB radio communication is determined and the position data is generated from this.

The pre-programmed position data is stored in the server or the position data obtained through automatic radio-based position determination is transmitted to the server, where it is used to create the three-dimensional map.

For easier identification of the first furnishing element, it may also be provided that an optical signal is emitted from the first furnishing element, and the optical signal is used to recognize the first furnishing element image. In this case, the optical signal can help to make identification easier based solely on its intensity standing out from the rest of the scene image or also its spectral distribution that is conspicuous there. This is particularly helpful when a single still image is to be used for recognizing the first furnishing element. In addition, if identification information is also to be transported along with the optical signal, in order to identify the type of a first furnishing element, for example, and thereby be able to infer its actual dimensions because, for example, these differing actual dimensions are pre-programmed according to type, it is advisable to capture a sequence of still images with suitable intervals between individual shots or to record a video sequence covering the information transmission.

The optical signal is preferably a light signal, i.e. electromagnetic radiation emitted from the first furnishing element. This light signal may have components in the range of the electromagnetic spectrum visible to the human eye. It is preferably a light signal not visible to the human eye but detectable by the camera.

However, the optical signal can also be realized by influencing the reflected light. Hence, the optical signal may be a code, for example, such as alphanumeric text, a barcode, a QR code or a symbol or the like displayed on a screen, in particular on an E-paper screen. In this case, the reflected light is therefore influenced in such a manner that an optical signal is created that is used for recognizing the first furnishing element image.

The camera may be a mobile camera, in other words, a camera capable of changing its position. Through the aforementioned measures and/or automatic positioning, such as by means of an Indoor Positioning System, for example, the position of a mobile camera of this kind can be determined. The determined scales for the respective scene image captured by the camera along its path can then be referenced to the camera's position, enabling the creation of a three-dimensional map. A mobile camera of this kind may be located on a shopping trolley, for example, or integrated in said shopping trolley.

It has proved particularly advantageous for the camera to be a camera installed in a stationary manner. This allows for easy spatial allocation of the captured image data or captured scenes. Furthermore, this measure ensures that each area targeted by the stationary installed camera can be permanently captured. It is thereby ensured that a three-dimensional map created using the method according to the invention for all scenes captured by stationary installed cameras can be continuously updated.

In summary, the measures according to the invention allow for the most efficient and, above all, accurate mapping of all furnishing elements in the relevant area, while also being highly precise and largely resistant to errors, resulting in a fully automatically generated layout of the furnishing elements referred to as a “floor plan” in the context of a retail business which creates a three-dimensional map of all furnishing elements (both first and second) recognized in the relevant spatial area (in this case, the retail premises). Finally, it should be generally noted that the electronic devices discussed naturally contain electronics. The electronics can be discrete or integrated, or also a combination of the two. Microcomputers, microcontrollers, Application-Specific Integrated Circuits (ASICs), possibly in combination with analog or digital electronic peripheral components, can also be used. Many of the functionalities of the devices mentioned are realized with the help of software executed on a processor of the electronics, possibly in conjunction with hardware components. Devices designed for radio communication usually have an antenna configuration as part of a transceiver module for transmitting and receiving radio signals. The electronic devices may also have an internal electrical power supply, which can be realized, for example, with a replaceable or rechargeable battery. The devices can also be powered by a wired connection, either through an external power supply or also by means of “Power over LAN.”

These and other aspects of the invention are illustrated by the figures discussed below.

### BRIEF DESCRIPTION OF THE FIGURES

The invention is again explained in greater detail below with reference to the accompanying figures with the help of exemplary embodiments which are not intended to limit the invention. In this case, the same components in the different figures are provided with identical reference signs. The figures show schematically:

FIG. 1 an electronic shelf label system with a camera and a shelf positioned in the camera's field of view as the scene, with electronic shelf labels;

FIG. 2 the shelf with the camera positioned in front of it in front view;

FIG. 3 the shelf with the camera positioned in front of it in plan view;

FIG. 4 the shelf with the camera positioned in front of it in side view from the left;

FIG. 5 an illustration of the electronic shelf labels within a scene image of the scene captured with the help of the camera.

### DESCRIPTION OF THE EXEMPLARY EMBODIMENTS

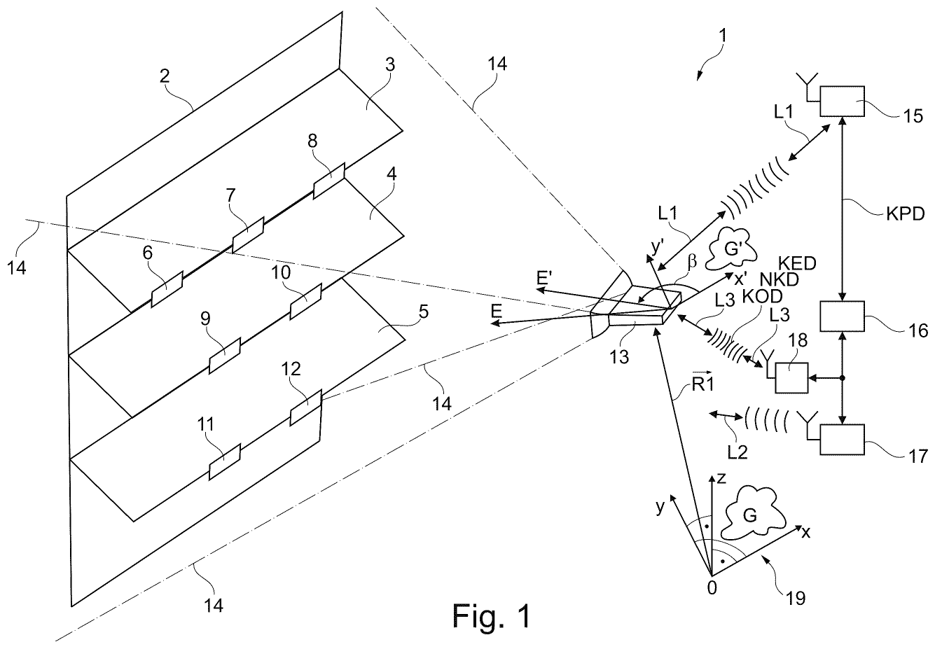

FIG. 1 depicts a basic configuration of an electronic shelf label system, referred to hereafter as the ESL system 1 (ESL stands for Electronic Shelf Label), for implementing or considering in detail the method according to the invention. The system 1 comprises:
a server 16 for creating and further utilizing a three-dimensional digital map of furnishing elements in retail premises belonging to a retailer, wherein shelves 2 with shelf boards 3-5 are set up in the retail premises for displaying goods (not shown here);
an Ultra-Wide-Band communication device 15, hereinafter referred to in short as UWB transmitter 15, wherein UWB stands for Ultra-Wide-Band in this case, for UWB radio communication with other UWB-enabled devices (indicated by first radio signals L1) for determining the locations of these UWB-enabled devices in the retail premises;
an ESL access point 17 for radio communication (indicated by second radio signals L2) with electronic shelf labels 6 to 12, hereinafter referred to in short as ESLs 6-12;
a camera access point 18 for radio communication with a camera 13 (indicated by third radio signals L3);
cameras 13, positioned with their image capture area on the shelves 2 as the scene to be captured and generating a digital scene image of this scene, in other words, of the shelf 2, and configured for radio communication with the camera access point 18 for the purpose of data transmission with the server, and for UWB radio communication with the UWB transmitter for the purpose of determining their position in the retail premises;
seven ESLs 6-12 positioned at the front edges of the respective shelves 3-5 (corresponding to products, although not shown here) for visualizing product and/or price information and configured for radio communication with the ESL access point 17 for obtaining the relevant product and/or price information from the server 16.

The ESLs 6-12 are supplied with the relevant product and/or price information from the server 16 via the ESL access point 17 in a manner known per se, with the help of so-called Label Management Software. In this context, a logical link stored digitally in the server 16 which binds each ESL 6-12 to the associated product (referred to as “binding” in the jargon), ensures that the ESLs 6-12 receive the correct data for visualization on their screens, which are typically designed as extremely energy-efficient, electrophoretic displays.

The fully automatic determination of the exact position of the shelves, and therefore also of the products located on them in the retail premises, is the subject matter of further discussion. The result of the method used in this case is a digital three-dimensional map of furnishing elements in the retail premises. In this case, the furnishing elements should be understood to mean, in principle, all objects that can be detected with the help of the camera(s) 13, which are located at various points in the retail premises, preferably suspended from the ceiling or integrated therein, or can also be fastened to other furnishing elements, such as the shelves 2 themselves, for example. Owing to the simplified discussion of the method in this case, only a single shelf 2 and a single camera 13 will be considered, but this should not be regarded as limiting the invention to only this configuration. Instead, a plurality of shelves 13 can also be captured with a camera. In practice, a sufficient number of cameras 13 will be positioned at various locations and with differently oriented coverage areas in the retail premises, in order to apply the method according to the invention as comprehensively as possible in the retail premises and to obtain the most complete digital three-dimensional map possible of the furnishing elements.

In order to map the furnishing elements in the retail premises, a Cartesian coordinate system 19 is first defined for the retail premises, as shown in the lower right of FIG. 1. By definition, the coordinate axes X and Y which are orthogonal to one another (in the sense of a coordinate system) run along the flat floor G, on which the shelf 2 also stands, and define a lowest reference plane, wherein in this case all furnishing elements are located above the reference plane and their distance from the reference plane along the upward-pointing Z coordinate axis orthogonal to this reference plane, the origin of which is at point O, is indicated. This reference plane could of course also be at a distance from the floor G. The orientation of the coordinate pair axes X and Y in the reference plane is arbitrarily chosen in this case. In practice, for example, a corner of the retail premises could serve this purpose.

Ultra-Wide-Band UWB radio communication between the UWB transmitter 15 and the camera 13 is used to determine the positioning of the camera, wherein the position of the fixed UWB transmitter 15 installed in the retail premises is known. The position data KPD obtained in this way for the camera 13 is transmitted from the UWB transmitter 15 to the server 16, e.g. via a Local Area Network (LAN, for short) connection. It should be noted here that it is also sufficient for the relative coordinates of the camera 13, which indicate the relative position of the camera 13 with respect to the UWB transmitter 15, to be capable of being transmitted to the server 16, and for the server 16, knowing the position of the UWB transmitter in the coordinate system 19, to calculate the position data for the camera 16. The position data KPD represents a position vector R1 indicating the position of the camera 13 through the camera coordinates KX, KY, KZ in the coordinate system 19.

So that the position and orientation of the furnishing elements in the retail premises can be determined subsequently, the orientation of the camera 13 in the spatial area of the retail premises is also taken into account. For this purpose, the camera 13 includes an electronic compass (not shown) indicating its orientation in a plane G′ parallel to the floor G. The orientation data KOD generated by the electronic compass in the camera 13 is transmitted to the server 16 and further processed there. The orientation of the camera 13 is visualized by the angle (beta) β, which runs in a plane G′ that is parallel to that spanned by the coordinate axes X and Y and is indicated by the coordinate axes X′ and Y′ originating at the location of the camera 13. By definition, the angle (beta) β is measured in this case from the X′ coordinate axis towards the Y′ coordinate axis.

As mentioned, the camera 13 is installed on the ceiling of the retail premises and its field of view 14 is oriented obliquely downwards from there, to be able to capture the shelf 2 as completely as possible. A central capture direction E of the camera 13 towards the centre of the shelf 2 is also indicated here. The projection of the central capture direction E onto the plane G′ is plotted as the projected capture direction E′, to which the angle (beta) β extends. The outer edges of the field of view 14 are also depicted or defined by dash-dotted lines and in this representation they are plotted running towards the four corners of the shelf 2. As discussed, the central capture direction E is rotated about the angle (beta) β relative to the x′-axis and additionally tilted downwards from the plane G′ spanned by the x′-y′ coordinates.

To further discuss the method, reference is made to FIGS. 2 to 5 below.

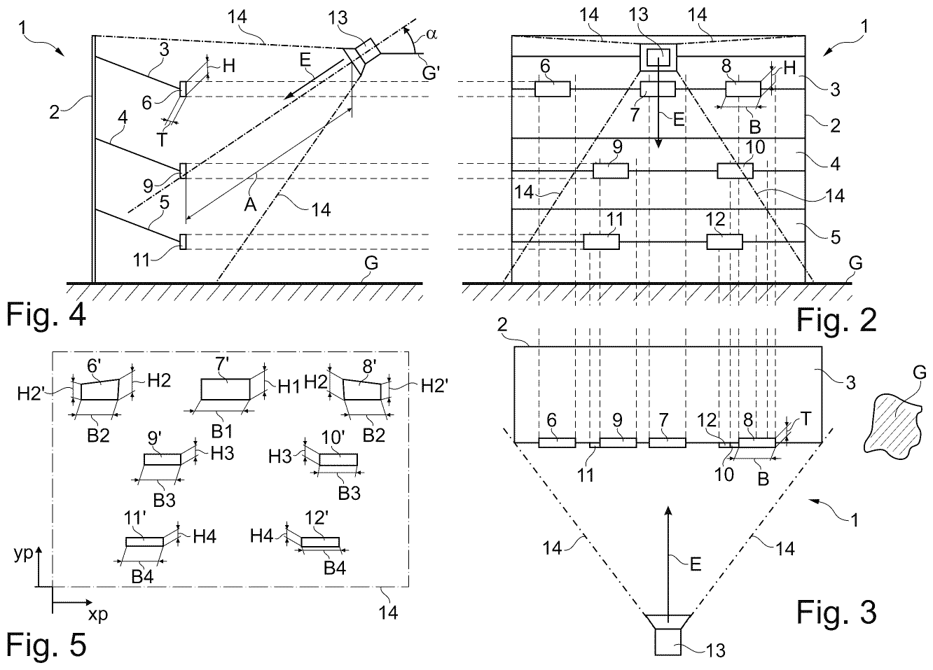

In this case, FIG. 2 shows a front view of the shelf 2 depicted in FIG. 1, with the camera 13 installed in the upper part of the view. FIG. 3 shows a plan view of this shelf 2 with the camera 13 positioned at a distance from it, and FIG. 4 shows a side view of the shelf 4 with the camera 13 positioned just under the ceiling of the retail premises at a distance from the shelf 2. A section through the floor G on which the shelf 2 rests can also be seen in FIGS. 2 and 4.

If, as can be seen in the present case, the camera 13 is fastened to the ceiling of the retail premises (not shown in detail) and consequently its central capture direction E is inclined downwards from the plane G′ spanned by the x′ and y′ axes (see FIG. 1), of which only part of an intersection line can be seen, the inclination of the camera 13 in the spatial area of the retail premises is also taken into account. For this purpose, the camera 13 includes an electronic gyroscope (not shown) which indicates the inclination of the central capture direction E from this plane G′. The inclination data KND generated by the electronic gyroscope in the camera 13 is transmitted from the camera 13 to the server 16 and further processed there. The inclination of the camera 13 is visualized by the angle (alpha) α, which is measured by definition from the plane G′.

Furthermore, the distance between the captured scene and the camera 13 is fixed or also determined, as discussed in the general description. In a simple approximation, the distance between the camera and the scene or a furnishing element of the scene can be calculated using the generally known lens equation, also known by the term “imaging equation”, as referred to in the relevant literature. The distance determined by measurement or calculation, such as the average distance along the central capture direction E in FIG. 4, is represented by distance data KED which either has its origins through calculation in the server 16 or is transmitted from the camera 13 to the server 16 and disseminated there.

So that furnishing elements can be located automatically and highly accurately in the retail premises, a scale is needed that enables the scene, or constituent parts thereof, captured with the help of the camera 13 to be placed in a real dimensional or positional context. This scale is determined with the help of first furnishing elements, namely with the help of the ESLs 6-12, which assume the role of reference elements since they have known dimensions, namely a known width B (e.g. 60 mm), a known height H (e.g. 30 mm) and a known depth T (e.g. 8 mm), wherein in the present case these dimensions B, H, T are identical for all ESLs 6-12.

With the help of the camera 13, a digital still image of the scene, in other words of the shelf 2 according to FIG. 1 (see also FIGS. 2-4), is captured and a two-dimensional digital scene image representing this scene is generated which is formed from 1100×700 pixels, for example. These pixels are arranged in a matrix, wherein the position of each pixel is given by pixel coordinates xp and yp, wherein xp is an element of the natural whole numbers from 1 to 1100 and wherein yp is an element of the natural whole numbers from 1 to 700. This scene image contains all real furnishing elements of the scene, such as the shelf 2 with its shelves 3-5, for example, possibly also with products placed on them. However, the ESLs 6-12 appear as the foremost image elements which are not covered by any other image elements. This prominent positioning, as well as their known dimensions, makes the ESLs 6-12 suitable as reference elements for determining a scale for the scene image.

In the present case, with the help of artificial intelligence integrated into the camera 13, the digital scene image is searched for the ESLs 6-12. Criteria can be used in this process, such as the substantially rectangular shape of the ESLs, which must be predominantly unaffected and easy to find, a dimension ratio, for example width divided by height, which facilitates and ensures the computerized detection of the ESLs 6-12 in the digital scene image. The result of this search is shown by way of example in FIG. 5, where in a search result image matrix of 1100×700 pixels, identified by the pixel coordinates xp and yp, only the located ESLs 6-12 can be seen, and all other furnishing elements have been hidden. It goes without saying that this representation mainly serves for simple visualization and discussion and, of course, in a complete collection of furnishing elements, the located ESLs 6-12 can be digitally marked, in other words labelled with metadata, in order to allow their further digital manipulation independently of the potentially existing variety of other furnishing elements.

As can be seen in FIG. 5, distortions of the proportions and shape of the ESLs 6-12 can occur in the digital image. In the present case, in particular, the ESL 7 depicted on the upper shelf 3 exhibits hardly any distortions or alterations in shape, because it is centrally positioned in front of the camera 13. The adjacent ESLs 6 and 8 predominantly exhibit a horizontally tapering shape which is due to their positioning on the left or right edge of the field of view 14 of the camera 13. By contrast to this, ESLs 9 to 12 substantially exhibit slightly distorted proportions, which is due to the fact that the camera 13 captures them from above, causing the projection area of the front face of ESLs 9-12 to decrease on the image sensor of the camera 13, the further the ESLs 9-12 are positioned within the lower field of view 14.

This can result in the ESLs 6-12 in the digital scene image having slightly differing heights H1-H4 and slightly differing widths B1-B4. However, their dimensions and proportions remain preserved to an extent that allows them to remain detectable by artificial intelligence.

After the ESLs 6-12 are located or identified in the scene image, a valid individual scale for the scene image is determined for each of the ESLs 6-12 at the location of each respective ESL 6-12. The scale essentially indicates how many pixels in the scene image correspond to a unit of length, such as 1 mm, for example, of the actual, namely known, dimension (such as the width B and/or the height H of an ESL, for example).

The scale is determined by counting the pixels along the outlines for each recognized ESL 6-12. The number of width pixels thereby determined along the pixel coordinate xp of each depicted ESL 6-12 is used as the divisor, in order to divide the actual width (as the dividend) by the number of width pixels. If the actual width is given in millimetres, for example, as previously discussed, then the scale along the pixel coordinate xp has the unit mm/pixel.

The number of height pixels thereby determined along the pixel coordinate yp of each depicted ESL 6-12 is used as the divisor, in order to divide the actual height (as the dividend) by the number of height pixels. If the actual height is given in millimetres, for example, as previously discussed, then the scale along the pixel coordinate yp has the unit mm/pixel.

Since these individual scales associated with the respective ESLs 6-12 substantially apply only at the location of each respective ESL 6-12 or in the immediate vicinity thereof, the course of the scales is interpolated between the individual ESLs 6-12. This interpolation can be quasi-continuous at the pixel level or also based on clusters of pixels, such as 10×10 pixels or 20×20 pixels, etc., for example.

Using the location-dependent scale thereby determined for the scene image, the actual dimensions of the shelf 2 contained in the scene image can then be precisely determined and the shelves 3-5 arranged in the shelf 2, which at their front edge can only run along the horizontal arrangement of the groups of ESLs 6-8, 9-10, 11-12 fastened there, can be located. The position of the respective ESLs 6-12 along the shelves 3-5, as well as their distances from each other, can also be specified in actual dimensions (e.g. in millimetres).

All of this is based on the approach that the pixels along the pixel coordinates xp and yp for each respective furnishing element image contained in the scene image (shelf outlines, shelf board 2-3 or spacing between shelf boards 2-3, possibly also packaging outlines of products, etc.) are counted and the number of pixels thereby determined along the respective pixel coordinates xp and also yp is multiplied by the respective location-dependent scale for the pixel coordinate xp or the pixel coordinate yp being used in each case. The entirety of the furnishing element images of the scene image thereby cartographically mapped in real, in other words actual, dimensions, which cartographically mapped entirety only constitutes a two-dimensional digital map of the scene due to the imaging onto a two-dimensional image sensor of the camera 13, can subsequently be brought into a three-dimensional context with reference to the coordinate system 19 using the aforementioned distance data KED, orientation data KOD, inclination data KND and position data KPD for the entering camera 13. For this purpose, the two-dimensional digital map of the scene, specifying the actual dimensions determined, is transmitted to the server 16, where it is supplemented with the distance data, orientation data, inclination data and position data for the entering camera 13, which is collectively referred to as supplementary data.

As mentioned above, in a real installation in the retail space of a retailer, any number of shelves or other product presentation furnishing elements may, in principle, be present, which can be mapped three-dimensionally in groups or individually with the help of the measures discussed. These furnishing elements to be captured in terms of their position and orientation can each be captured by a single camera 13 or also by at least two cameras 13 in a partially overlapping manner. In all implementation variants, the first furnishing element, the actual dimension of which is known, plays a central role in determining the scale for the scene image, in order to provide the images of the furnishing elements contained in the respective scene image with actual dimensions, to be able to specify their relative positions to one another in actual dimensions or also to be able to specify their absolute positions in the scene, which is for an automatic, computerized creation of a digital floor plan, which forms a digital three-dimensional map of all furnishing elements detectable with the help of the cameras 13. This digital floor plan is made accessible to the label management software on the server 6 for further use.

In this way, with the help of the cameras 13, e.g. the contents of the screens can be captured and the label management software can be provided with information on the exact actual positions of the ESLs in the retail premises.

If ESLs are used in the ESL system that have a light-emitting device such as an LED (Light-Emitting Diode), the identification code of the respective ESLs can also be captured via the camera 13, e.g. in a series of still images or with the help of a video sequence, possibly also evaluated immediately, and transferred to the server 16 for further use with the label management software. The emitted light can also be used with the camera 13 to make it easier to locate the respective ESL in the scene image.

Similarly to this, so-called shelf dividers can also be used in the context of the present invention as the first furnishing element or as the reference element, because they also have an actual dimension that is known in principle beforehand. Shelf dividers have substantially rectangular, for example panel-shaped, structures, which are positioned to separate products on a shelf board between adjacent products. These shelf dividers can also be equipped similarly to the ESLs with an LED and emit a light signal as the optical signal for the aforementioned purposes.

According to another configuration of the ESL system 1 or a subset thereof, it may also be provided that the camera 13 is not mounted on the ceiling of the retail space but, for example, on a shelf rail in a central position of a shelf. The camera 13 then captures another shelf across an aisle as the scene, wherein any distortions in the scene image that occur run symmetrically around the centre of the scene image and may therefore be easier to take into account. Additionally, in this configuration, hardly any additional mounting measures are necessary for the camera 13.

Finally, it should be mentioned that it is not strictly essential to use a location-dependent scale for the scene image. A uniform scale can also be applied to the entire scene image, in particular if the errors associated with it would be acceptable or even negligible, which may arise, for example, from the specific requirement profile of the retailer.

Finally, it once again pointed out that the figures described in detail above are merely exemplary embodiments that can be modified by a person skilled in the art in a wide variety of ways, without departing from the scope of the invention. For completeness, it is also pointed out that the use of the indefinite articles “a” or “an” does not exclude the possibility that the features concerned may also be present multiple times.

1. A method for determining the position of furnishing elements,
wherein a digital scene image consisting of pixels, in particular with a known pixel spacing or a known pixel dimension, and containing a digital representation of a first furnishing element, is generated using a camera (13) from a scene captured by it, in which at least one first furnishing element (6-12) is present and
wherein the at least one first furnishing element image is automatically recognized in the scene image and
a scale for the scene image is determined by determining the image points associated with the first furnishing element image in the scene image and knowing the actual dimensions of the first furnishing element (6-12).

2. The method according to claim 1, wherein multiple first furnishing element images, preferably identically configured first furnishing elements (6-12), are identified in the scene image, wherein the actual dimensions of the underlying multiple first furnishing elements (6-12) are known, and the scale for the scene image is determined with knowledge of the actual dimensions.

3. The method according to claim 1, wherein the first furnishing element (6-12), the actual dimensions of which are known, is formed by an electronic shelf label (6-12).

4. The method according to claim 1, wherein the determination of the pixels associated with the first furnishing element image in the scene image can be carried out using at least one of the measures listed below, specifically:
determination of the number of pixels occupied in a surface-like manner by the first furnishing element image,
determination of the number of pixels occupied by the first furnishing element image around its circumference or the number of pixels surrounding the first furnishing element image around its circumference,
determination of the number of pixels occupied by the first furnishing element image along one of its boundary lines or the number of pixels surrounding the first furnishing element image adjacent to one of its boundary lines.

5. The method according to claim 1, wherein the scale indicates a unit of area or length in the scene per pixel for the scene image.

6. The method according to claim 1, wherein at least one second furnishing element image is recognized in the scene image and using the scale for the scene image, at least one actual measurement for the second furnishing element underlying the second furnishing element image is determined.

7. The method according to claim 6, wherein the actual measurement comprises at least one of those listed below, specifically:
an actual size measurement of the second furnishing element,
an actual distance measurement of the second furnishing element from another furnishing element also recognized in the scene image,
an actual position measurement of the second furnishing element within the scene captured by the camera (13).

8. The method according to claim 1, wherein based on the totality of the furnishing element images recognized in the scene image and using the scale for the scene image, a first data structure is generated that represents a two-dimensional digital map of the furnishing elements in the scene, specifying the actual measurement(s) needed for two-dimensional cartography.

9. The method according to claim 8, wherein the first data structure is converted into a second data structure by additional data, representing a three-dimensional digital map of the furnishing elements in a spatial region relevant to their positioning, wherein the additional data includes at least one of the following data elements, specifically:
distance data (KED) indicating the distance of the camera (13), in particular a mean or representative distance, from the scene captured by it, in particular the first furnishing element (6-12) contained in the scene,
orientation data (KOD) indicating the orientation of the camera (13) in the spatial region;
tilt data (KND) indicating a tilt of the camera (13) in relation to a reference, particularly the direction of gravity;
position data (KPD) indicating a position of the camera (13) within the spatial region.

10. The method according to claim 9, wherein the distance represented by the distance data (KED) can be determined in at least one of the following ways, specifically:
by pre-programming,
by automatic calculation with knowledge of the parameters of the optical imaging system of the camera (13),
by automatic determination by means of a distance sensor.

11. The method according to claim 9, wherein the orientation represented by the orientation data (KOD) can be determined in at least one of the following ways, specifically:
by pre-programming
by automatic determination by means of an orientation sensor.

12. The method according to claim 9,
wherein the tilt represented by the tilt data (KND) can be determined in at least one of the following ways, specifically:
by pre-programming,
by automatic determination by means of a tilt sensor.

13. The method according to claim 9, wherein the position represented by the position data (KPD) can be determined in at least one of the following ways, specifically:
by pre-programming,
by automatic radio-based position determination, in particular with the help of “Ultra-Wideband (UWB) radio technology.”

14. The method according to claim 1, wherein an optical signal is emitted from the first furnishing element (6-12) and the optical signal is used to recognize the first furnishing element image.

15. The method according to claim 1, wherein the camera (13) is a camera (13) installed in a stationary manner.
